(19) United States
(12) Patent Application Publication
(10) Pub. No.: US 2016/0188547 A1
(43) Pub. Date: Jun. 30, 2016

(54) Electronic digital card system comprising a web-based interactive card, mobile app viewer and organizer, website, online design tool and integrated design environment, and remote central server

(71) Applicant: Nazareno Cruzada, San Marcos, CA (US)

(72) Inventor: Nazareno Cruzada, San Marcos, CA (US)

(21) Appl. No.: 14/797,863

(22) Filed: Jul. 13, 2015

Related U.S. Application Data
(60) Provisional application No. 62/024,211, filed on Jul. 14, 2014.

(51) Int. Cl. G06F 17/22; G06F 17/21; G06F 3/0484; G06F 21/57; G06F 3/0481; G06F 3/16; H04L 29/08; G06F 3/0482; G06F 17/24

(52) U.S. Cl. CPC G06F 17/2247; G06F 3/0482; G06F 17/2235; G06F 17/218; G06F 17/2205; G06F 3/04842; G06F 17/248; G06F 3/04817; G06F 3/04845; G06F 17/2252; G06F 3/16; H04L 67/02; G06F 21/57; G06F 2221/034

(57) ABSTRACT

An electronic digital card system comprised of an interactive web-based digital card created using HTML, CSS, Javascript and other web technologies, a mobile application that is used to create, view, transmit, store and organize the digital cards, a central website where users can register and download the mobile app and view a card registry and listings, an online card design tool and integrated design environment, and a remote central server that the design tool and mobile app communicates with.

I claim priority of provisional application 62/024,211 filed on Jul. 14, 2014 titled “Electronic business card system comprising a web-based interactive card, mobile app viewer and organizer, website and remote central server.”

### BACKGROUND OF THE INVENTION

1. Field of the Invention

The invention relates to an interactive electronic digital card, and more specifically to an electronic digital card and a system for designing, transmitting, storing and organizing electronic digital cards comprising of a mobile app, a website, a digital card design tool and integrated design environment, and a remote server. Digital cards used in the context of this system include digital business cards, mobile tickets, and digital flash cards for studying. Mobile tickets include tickets for sports events, music concerts, train & bus tickets, and other events.

2. Description of the Prior Art

The prior art of this invention includes paper business cards, paper event tickets, paper transportation tickets, paper flash cards as well as electronic systems to implement digital versions of these paper cards and tickets.

The use of paper-based business cards is still a standard practice in business, even with advances in technology such as inter-device communication like Bluetooth, and standard electronic card formats such as the vCard or Virtual Card Format (.vcf) and the hCard or HTML card format. There are several reasons for this, including the ease and quickness by which one can just hand over one's card to another person. Also, the tactile feel of the paper used on the card along with the formatting and graphic design of a card can communicate rich information about the owner of the card, more so than just the contact information printed in the card. The hCard or HTML card format comes close to mimicking the graphical display of a paper card but the method of the data formatting and markup in an hCard makes it difficult to parse the contact information for organizing and storing of multiple hCards. This is because the format uses the class attribute on an element to designate which vCard field the value of an element is. An example of a hCard markup is:

```
<div class=“vcard”>
    <div class=“fn org”>Wikimedia Foundation Inc.</div>
    <div class=“adr”>
        <div class=“street-address”>149 New Montgomery Street, 3rd
Floor</div>
        <div> <span class=“locality”>San Francisco</span>, <abbr
class=“region” title=“California”>CA</abbr> <span class=“postal-
code”>94105</span></div>
        <div class=“country-name”>USA</div>
    </div>
    <div>Phone: <span class=“tel”>+1-415-839-6885</span></div>
    <div>Email: <span class=“email”>info@wikimedia.org</span>
    </div>
    <div class=“tel”>
        <span class=“type”>Fax</span>:
        <span class=“value”>+1-415-882-0495</span>
    </div>
</div>
```

There is also no user-friendly and easily available system to manage, send and organize hCards.

However, there are other electronic systems for digital business cards that exist. These systems have their own digital format and include products from companies such as Moo (www.moo.com), Snapdat (www.snapdat.com), TapMyBiz (www.tapmy.biz), ClickCard (https://play.google.com/store/apps/details?id=Gerold.Beckers.BusinessCard), Business Card Book (https://play.google.com/store/apps/details?id=mobi.businesscardbook), CardShake (https://play.google.com/store/apps/details?id=Tesla.Android.CardShake), CamCard (https://play.google.com/store/apps/details?id=com.intsig.BizCardReader), Bizecards (www.bizecards.com), Prestoh Mobile Business Card (http://prestoh.com/about/mobile_business_cards), ouR-Card (www.our-card.com), and Vizibility (www.vizibility.com). In my research, these products do not have the complete set of features and functions as claimed in this application that make this invention unique and novel.

The use of paper-based tickets is still a standard practice in business. However, there have been many ventures and efforts into the use of digital mobile tickets. Businesses from sports teams, event venues, transportation agencies, and ticketing companies have implemented electronic ticketing systems that deliver digital mobile tickets. Companies such as TicketMaster, Eventbrite, LiveNation and others also have electronic online ticketing systems with some limited mobile capability. In my research, these systems do not have the complete set of features and functions as claimed in this application that make this invention unique and novel.

The use of paper flash card is still a standard practice in school—from grade school to college and university, as well as in trade school. There are, however, several companies that provide digital flash card products from Chegg Flashcards (www.chegg.com), StudyBlue (www.studyblue.com/online-flashcards), Flashcard Machine (www.flashcardmachine.com), Flashcards Deluxe (www.OrangeOrApple.com), and Cram (www.cram.com). In my research, these products do not have the complete set of features and functions as claimed in this application that make this invention unique and novel.

### SUMMARY OF THE INVENTION

This invention is an interactive electronic digital card and a system for the design, creation, publishing, viewing, transmitting, storing and organizing of electronic digital cards comprising of a mobile app, a website, a digital card design tool and integrated design environment, and a remote server.

The interactive electronic digital card is created using existing web-based technologies and file formats such as HTML, CSS, JPEG or GIF image files, Javascript and a vCard or Virtual Card Format (.vcf) data file.

Another component of the system is a framework of meta HTML, CSS and Javascript files that provide graphical presentation and navigation infrastructure for the card, and provides a security infrastructure to prevent rogue code from executing on a user's mobile device.

Another component of the system is a mobile app that allows users to create, view, transmit, store and organize these digital cards. The rise in popularity of smartphones and tablets with graphically rich display screens can support the presentation of graphically rich and interactive digital cards via a mobile app which in turn will support long term adoption of this technology.

Another component of the system is a website where visitors can find out about the system and the company operating the system, to register to become users of the system and to download an installation of the mobile app. This website has a business card directory that stores electronic business card files of cards that have been made public by their owners, and makes them available for web viewing.

Another component of the system is an online digital card design tool and integrated design environment called a design studio, where web designers can create and design digital cards to publish and download to the mobile app.

Yet another component of the system is a remote server. This remote server functions as a repository of created and published digital cards and as the central hub of communications with the design tool and mobile app. This remote server is also called the card server.

### DETAILED DESCRIPTION OF THE INVENTION

The invention is composed of several components. These components are:
1. An interactive electronic digital card created using web technologies
2. A mobile app
3. A central website
4. A central online card design tool and integrated design environment, also called the design studio
5. A central remote server, also called the card server

The interactive electronic digital card functions as either a digital business card, event ticket, transportation ticket or flash card and is created using existing web-based technologies and file formats such as HTML, CSS, JPEG or GIF image files, Javascript and a vCard or Virtual Card Format (.vcf) data file for business cards. This digital card is essentially a graphics oriented mini-website with clickable links and images.

The card's size in inches varies based on whether it is a business card, a ticket, or a flash card. In general, the size will stay within the size limit of a standard or typical smartphone LCD screen which is from 4.5 to 5.5 inches diagonally.

The base embodiment of a digital card includes at least one HTML file and may also include one vCard or Virtual Card Format (.vcf) data file, one or more digital image files, a Javascript file, or a CSS file. The HTML file may contain the card owner's vCard or .vcf contact information and mark it up by using the “id” attribute, as shown in FIG. 2.

By using the “id” attribute instead of the class attribute, retrieval of the field values are easier by using Javascript's getElementById function, as shown in FIG. 3.

In this system, a digital business card will be the size of a standard business card. This standard size varies by region or country but on average it is 3.5 inches in width by 2 inches in height or 350-460 pixels by 200-250 pixels. These specific graphic size configurations are designed to limit the viewable size of the card to the standard size of a paper card. This configuration differs from existing websites that can resize into smaller scale when viewed from a mobile device. The HTML, CSS, JPEG or GIF image files, and Javascript files provide the card's visual presence and layout. Several examples are given in FIGS. 1, 6 and 7.

In this system, a digital mobile ticket will vary in size depending on the size of a typical paper ticket of its type. So, a sports event ticket will be similar in size to a typical size of its paper counterpart, and a music concert ticket will be of similar size to a typical music concert ticket.

The HTML file provides interactivity via the use of hyperlinks, buttons, or mailto tags for email addresses. The mailto tag may launch an email client app when clicked. If the card has a phone number field, this field may be configured with a custom tag that when clicked, launches the mobile phone's dialer.

Another embodiment is to include one or more digital image files in JPEG, GIF, PNG formats in the graphical layout of the card. A digital image from a scan of the actual paper card can be used as a base of the layout and then HTML is used to position the interactive links on top of the image, as in FIGS. 4-7. This embodiment is quite possibly the most likely scenario that is taken as the next step up from using a paper card as it's quite easy to scan a paper card as in FIG. 4, and have someone skilled in HTML to write code to wrap around the image file, as in FIG. 8. A result of this method is shown in FIGS. 6 and 7.

Another embodiment is to include a CSS file which provides a more precise control in the graphical layout of the card. Another embodiment is to include a Javascript file which provides more interactivity with its response to screen click or touch events. The Virtual Card Format data file is an industry standard file format and contains data on the owner of the card such as First Name, Last Name, Company Name, Job Title, etc. The combination of the vcf data file and the web files create a unique combination of files that provide visual presentation, interactivity and an industry standard format for electronic contact data information. Together, all of these files comprise the interactive electronic business card and are packaged into an industry standard file format for packaging multiple files. These industry standard file formats include, but are not limited to the ZIP (.zip) or RAR (.rar) file formats. The use of these industry standard file formats and web technologies leverages the existing skills of a large population of web designers and ultimately help towards easier and faster adoption by the general population.

Another component of the system is a framework of meta HTML, CSS and Javascript files that determines and implements standard coding and file naming conventions, provides graphical presentation and navigation infrastructure for the card, and provides a security infrastructure to prevent rogue code from executing on a user's mobile device.

An embodiment of the framework's standard file naming convention is the mandate for the use of one HTML file that is named Index.html, the name of StyleSheet.css for a file that stores any CSS code used, and the name of Scripts.js to store any Javascript code that the card uses.

FIG. 13 shows an embodiment of this framework in an HTML file. A card's HTML markup goes inside this meta HTML's body element. Providing a meta HTML document framework where the card's partial HTML code is loaded as a child element of the meta HTML's body element lessens the scope of control of a card's code on the system and computing environment. It also sets the meta styling and layout of the card. When this HTML file is loaded, the onBodyLoad( ) function is called, which loads the card files into the body of the meta HTML file. This function is located in the framework's meta Javascript file.

FIG. 14 shows an embodiment of this framework in a Javascript file. This file provides functions that can be used by a card's code to navigate to or load other pages. Notice the onBodyLoad( ) function which was called from the meta HTML file.

As an example of how the code in FIG. 8 would be embodied within this system and framework, such an embodiment is shown in FIGS. 15 and 16. The card's HTML code is stored in a Index.html file while the card's CSS styling code is stored in the StyleSheet.css file.

FIGS. 17 to 18 show another embodiment of an interactive card. The tabs on the top left provide navigation from one page of the card to another.

FIGS. 19 to 21 show embodiments of the HTML and CSS code of the card shown in FIGS. 17 to 18, within this framework. This card has a more sophisticated design and therefore contains more complex code. Notice the use of one Index,html file as the home page and main entry point for the card. Also notice the use of the framework navigation function loadPage( ), which can be seen in the card's HTML files in FIGS. 19 and 20.

In addition to designing and creating digital cards, the online design studio and IDE can also allow web designers to design and create digital card templates. Card templates are similar to digital cards but are structured such that they contain placeholders for standard data fields for that particular type of card. For example, if the card template is for digital business cards, then the template will have a placeholder for data fields such as first name, last name, job title, company name, etc. If the card template is a template for a sports ticket, then the template will have a placeholder for data fields such as seat number, stadium level, ticket price, game date and time, etc. These placeholders are HTML element tags that are defined and identified with the name of the corresponding data field that it holds. In FIG. 15, the contents of an interactive card's Index.html file shows placeholders for a business card owner's work telephone number, mobile phone number, email and company website.

Card templates are designed and created in the online design studio and IDE and published to the card server. Once published, they are then available to other designers in the online design studio as well as to users of the mobile app. Card designers using the online design studio can create new digital cards by choosing a published card template from a image thumbnail list presented via a screen in the design studio. Users of the mobile app can create a new digital card by also choosing a published card template from a image thumbnail list presented via a screen in the mobile app. This image thumbnail list screen in both the design studio and the mobile app is dynamically created by querying the card server to retrieve a list of published card templates.

Another component of the system is a mobile app that allows users to view, transmit, store and organize these business cards. A web browser graphical control is embedded in a screen of the app. The card is then viewed via this browser control. A user of the system can use the mobile app to send his or her card to another user. The mobile app transmits the card files in the package file format using either the SMTP internet messaging protocol, the MMS messaging protocol, or via a Bluetooth connection to the recipient's mobile device. The SMTP internet messaging protocol is widely used and more popularly known as email. The MMS messaging protocol is also widely used and more popularly known as text messaging. The mobile app can also use near field communications (NFC) technology or acoustic signals to transmit a card ID to a second mobile device which then uses the card ID to request the card files from the card server. A card ID is used in this situation since current NFC and acoustic technology do not have the capacity to transmit the size of files that card files tend to be. Currently this limit is around 200 kilobytes.

Near field communications (NFC) is a fairly new technology that allows communications between electronic devices at close length. A lot of NFC applications involve waving or ‘swiping’ an NFC enabled device near another electronic device emitting an NFC signal. NFC technology may leverage the use of existing Bluetooth communications technology. An NFC enabled embodiment of this system involves attaching an NFC sticker to the back of a paper business card, thereby enabling it to emit an NFC signal. The NFC sticker would be loaded with the unique card data or ID of a card owner. When the card owner presents the card to a second person, the second person can place an NFC enabled smartphone or device with the mobile app installed in close proximity to the card, thereby allowing the app to read the data on the NFC sticker of the card. If the NFC sticker can hold the entire data of a card package file, the app can download and import the entire contents of the card package file. If the NFC sticker is loaded with a user ID, this data is downloaded by the app and sent to the remote server to request the card package file. If the remote server responds with the card package file, it is then imported by the app into its files storage.

Another NFC enabled embodiment of this system might involve a clip-on badge normally used at conferences and events by attendees. The clip-on badge may be attached with an NFC tag or sticker. The wearer of the NFC enabled badge may then allow other persons he or she meets at the event to wave their NFC enabled smartphone near his or her badge to receive and import the card package file or user ID data of the badge wearer. If the system's mobile app is installed in the smartphone and if the NFC sticker is loaded with a user ID, the app can then query the remote server to download the card package file and store it in the app. Another embodiment of NFC use by the system may involve the use of standard business card holders or dispensers. Instead of having to fill the holder or dispenser with a stack of cards and having to refill it when it becomes empty, the user can simply NFC enable the card holder/dispenser with an NFC tag or sticker loaded with the card package file or user ID data.

Another method that the app uses to transmit the card ID or the card files is via acoustic or sound signals. The app does this by converting the digital data into analog sound signals which are received by the receiving app which converts the analog sound back into digital format.

Bluetooth technology is also widely used on current mobile devices as a way to communicate with other nearby devices.

When a user is sent a message with an interactive electronic business card package file associated with the system, the user can elect to open the package file and store the card files contained within the package file on his or her mobile device for viewing at a later time using the mobile app. The transmitted message containing the card package file also contains a clickable link to download and install the mobile app. This link is useful if the recipient does not currently have the mobile app installed in his or her mobile device.

The mobile app contains a directory structure that allows the user to create directories or folders to organize the stored card files into categories such as industry or profession. A user may elect to create directories or folders with names such as “Dentists”, “Real Estate”, “DC Attorneys”, etc. The mobile app provides a screen that allows the user to navigate thru the directories and folders that contain the stored card files, list the cards stored in each directory or folder, and to sort the stored cards in ascending or descending order. When showing the list of cards stored in each directory or folder, the mobile app retrieves data from the .vcf file associated with each card to present the card owner's contact information onto the list. When a user wants to view the business card of a contact on the list, he or she clicks on the list item, at which point the mobile app reads the electronic files of the business card locally stored on the mobile device, then presents a graphical view of the card on a screen on the mobile app.

When the app receives card ID data from via sound or NFC (via a second device or NFC enabled object) and the app cannot connect to the remote server, the app saves the card ID data for later use and allows the user to retry communicating with the remote server the next time internet connectivity is available. When the app successfully communicates with the remote server, sends the card ID data and downloads the card files, the app saves the card files into a local file directory on the mobile device. These locally saved card files can then be viewed, browsed and sorted via a Card Directory screen in the mobile app.

One of the functions of the Card Directory screen is to provide the ability for the user to add or edit a note for a card in the directory. By choosing a menu option accessed in the Card Directory screen, the user is presented with a screen form where the user can type in a short note and save it locally with the card files.

Another function of the Card Directory screen is to provide the ability for a user to save or import the contact info of a business card into the user's phone contacts database. By selecting a card on the directory list, a user can choose a menu option to ‘Save To Contacts’ at which point the app will retrieve the card's contact info and save or import it to the local Contact database of the mobile app.

The mobile app has a ‘My Cards’ feature and database that provides the ability for the user to store and manage his or her card or cards. The app has a ‘My Cards’ screen that lists any cards that the user has stored in the app. The app also provides the ability for the user to design and create digital cards via a user friendly ‘card design wizard’ that presents card design templates and layouts.

This Card Design Wizard guides the user thru the dynamic creation of a new digital card by presenting a series of screens which allow the app user to create a new digital card by presenting a screen of an image thumbnail list of available card templates that are located either locally to the mobile device or downloaded from a remote server and allowing the user to choose a specific card template and then allowing the user to customize the card by choosing image files local to the device to replace image files on the card template. When the user selects a thumbnail image of a card template, if the template is local to the device, the wizard will copy the local files into a new local folder location for the new card. If the template is online, the wizard will then download the card template files and create a digital card using the downloaded template files. The wizard will also create a new vcf file with the mobile app user's contact info such as first name, last name, job title, company name, etc and saving the digital card files locally in the device storage.

Once the user creates the card, the app will save it into the app's ‘My Cards’ file storage. The user can also load digital cards that have been designed by a third party web designer that the user may have paid to design his or her card.

When the user has one or more cards stored in the ‘My Cards’ storage, the app allows the user to request to have his or her card preloaded into the app on future downloads and installs of the app. The user can navigate to a screen where the user can electronically submit a request to a remote server to be reviewed by a system administrator. If the request is approved, the user's card is then organized and packaged along with other cards, into a preload package file designated for a particular city or area. A plurality of these preload packages representing multiple cities, zip codes or metropolitan areas are stored in the remote server. When the user installs and configures and uses the mobile app, the mobile app communicates with the remote server, wherein the preload package file gets downloaded by the mobile app. The preload package that the remote server gives to the mobile app to download is determined by the current location provided by a GPS or location service on the mobile device that the mobile app is running or is determined by the remote server. Once downloaded the preload package is unpackaged or unzipped by the mobile app and the preloaded cards are stored locally in the mobile device in the Card Directory of the mobile app.

To provide security and credibility, the app only allows users to load third party designed cards into this ‘My Cards’ database if the user provides a ‘card design password’ that the third party web card designer generated while using an online card design studio that is also part of the system and which the card designer then provides to his or her client, the app user. Also, the app limits the user on sending out cards that are listed in the app's ‘My Cards’ database or to forward received cards only if the card is designated in the system as a ‘public’ card. Cards designated as ‘private’ can only be given by the original owner of the card and cannot be forwarded by the receiver.

Another component of the system is a website where visitors can find out about the system and the company or business operating the system, to browse thru a public business card directory, upload their card to be included and listed in the business card directory, to register an account into the system, or to download an installation of the mobile app. To provide ease-of-use of the website and the registration process, site visitors who want to register are encouraged to have their packaged electronic business card files ready to upload into the system. If a site visitor registers by uploading packaged card files, the website registration form parses the .vcf data file in the uploaded package file and uses the information to prefill the registration form. The user then just needs to fill in his or her password in the registration form. The business card directory stores electronic business card files of cards that have been made public by their owners, and makes them available for web viewing. The card directory is categorized by location, industry or profession. It is also sortable and searchable. This website hosts cards that have been made public by their owners, and these cards are accessible and viewable via their own unique URL. An example of an embodiment is shown in FIG. 22.

By being accessible from its URL, the card can then be embedded into another webpage, such as the card owner's blog, using the HTML iframe tag, as shown in FIG. 23:

Another component of the system is an integrated design environment that can be used by web designers for the design of these interactive cards. This integrated design environment, also known as an “IDE” includes card design tools such as a project workspace container, a project workspaces manager, a multi-page design management screen, a code editor, a code validator and design preview screen, image file uploader, a third party framework loader (for frameworks such as jQuery, Bootstrap, Font Awesome, etc) and a card files packager. This design environment also provides a framework that includes meta HTML, CSS and Javascript files that determines and implements standard coding and file naming conventions, and provides graphical presentation and navigation infrastructure for the card. The framework also handles the loading of popular CSS and Javascript frameworks that help with web design, such as Bootstrap, jQuery, and Font Awesome. The framework also provides a security infrastructure to prevent rogue code from executing on a user's mobile device. This integrated design environment can be embodied either as an online service accessible via browser or a desktop application.

Yet another component of the system is a remote server. This remote server functions as a central storage for card packages, a central component for the creation of new digital cards that are mobile tickets, and the central hub of communications with the design tool and the mobile app. When a card designer wants to publish his or her card to this remote server—also called the card server—the design tool communicates with this remote server. When a user wants to upload his or her card to the public directory or to download a public card from the directory, the mobile app communicates with this remote server. When a user wants to back up his or her collection of received cards to the cloud or to retrieve a backup of these cards from the cloud, the mobile app communicates with this remote server. This remote server can also send system updates or alerts to the mobile app.

If the mobile app sends a request for a digital card that is a mobile ticket, this remote server can dynamically generate a digital card package for the mobile app to download. The newly generated card may or may not have unique ticket IDs or scan code image that are also dynamically generated. The dynamic ticket ID, scan code image and card package generation process used by this remote server can be done via one of several methods:
1. the entire ticket card package creation including ID and scan code image creation, numbering & pricing logic, is done on the remote server.
2. the ticket card package file is created on the remote server using data provided via an API call to a third party remote ticketing system. The digital ticket has placeholders which gets filled with the ticket data fields (event name, ticket number, seat number, scan code, etc). The scan code image creation for this scenario can be done on either the remote server or the third party remote ticketing system.
3. the ticket card package file is created fully on the third party remote ticketing system, so when the mobile app requests the ticket to the remote server, the remote server calls to the third party remote ticketing system to pull down the ticket file, then turns around to push it down to the mobile app.

### BRIEF DESCRIPTION OF THE DRAWINGS

FIG. 1: Various page views of an embodiment of a multi-page interactive electronic business card using HTML markup, CSS styling, Javascript and image files

FIG. 2: The HTML code of a digital card containing the card owner's vCard or .vcf contact information and mark it up by using the “id” attribute.

FIG. 3: The HTML code of a digital card using the “id” attribute instead of the class attribute, which allows easier retrieval of the field values by using Javascript's getElementById function.

FIG. 4: An untouched digital scan image of a paper card

FIG. 5: A digital scan image of a paper card with contact data field values removed

FIG. 6: An embodiment of an interactive electronic business card using a digital image of a scanned card with contact data field values removed and replaced with live HTML ‘mailto’ and ‘tel’ or ‘callto’ clickable links using.

FIG. 7: An embodiment an interactive electronic business card using an image of a scanned card with contact data field values removed and replaced with integrated Skype clickable links.

FIG. 8: An embodiment of a card created using HTML markup to encase and package a basic scanned image card to upgrade it into an interactive electronic business card. Note the use of the ‘class’ attribute to apply styling and positioning to the element, while the use of the ‘id’ attribute to apply a unique identifier to each element holding contact data.

FIG. 13: An embodiment of the framework in an HTML file.

FIG. 14: An embodiment of the framework in a Javascript file.

FIG. 15: Contents of an interactive card's Index.html file

FIG. 16: Contents of an interactive card's StyleSheet.css file

FIG. 17: Interactive card home page

FIG. 18: Interactive card contact page

FIG. 19: Contents of an interactive card's Index.html file

FIG. 20: Contents of an interactive card's Contact.html file

FIG. 21: Contents of an interactive card's StyleSheet.css file

FIG. 22: An embodiment of a URL of a digital card that has been made public by their owner, and is accessible and viewable via their own unique URL.

FIG. 23: An embodiment of an HTML iframe tag with the URL of a digital card that has been made public by their owner. This iframe tag can then be embedded into another webpage.

FIG. 24: An embodiment an interactive electronic card as a mobile music concert ticket.

FIG. 25: Contents of an interactive mobile music concert ticket's html file

FIG. 26: Contents of an interactive mobile music concert ticket's CSS file

FIG. 27: An embodiment an interactive electronic card as a digital flash card. To view the answer, a user would swipe across the screen of the mobile phone.

FIG. 28: An embodiment an interactive electronic card as a digital flash card. The answer is revealed after swiping across the screen. To navigate thru the cards, the user would tap on the ‘Back’ or ‘Next’ links.

FIG. 29: An embodiment an interactive electronic card as a digital flash card.

FIG. 30: Contents of an interactive digital flash card's html file

FIG. 31: An embodiment an interactive electronic digital card as a mobile train ticket.

FIG. 32: Contents of an interactive mobile train ticket's html file

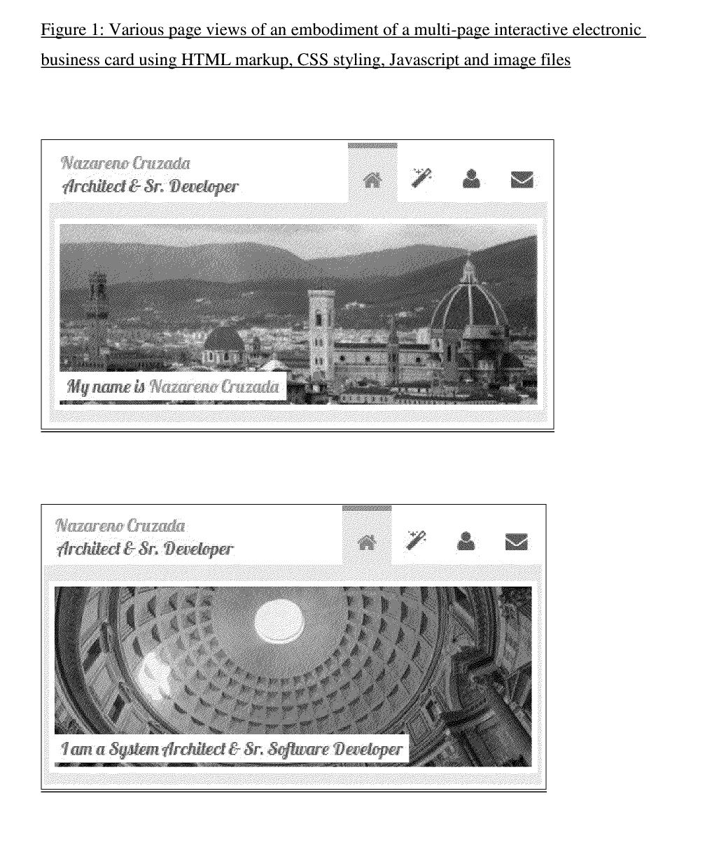

What is claimed is:

1. An electronic interactive digital card that functions as either a digital business card, event ticket, transportation ticket or flash card; and is embodied as an electronic package file such as a ZIP or RAR format, including at least one HTML file; with an option to include one vCard or Virtual Card Format (.vcf) data file, one or more digital image files, a Javascript file, or a CSS file; wherein this digital card is designed and created using an online design tool then uploaded and published to a remote server for download access by a mobile app; wherein this card package file is downloaded then unpackaged or unzipped by a mobile app and the files stored locally on a mobile device where the app is running; wherein the mobile app provides a list screen as a Card Directory to view a list of cards stored on the device and webview screen to individually view each digital card as a web page that the app user can interact with its graphical interface.

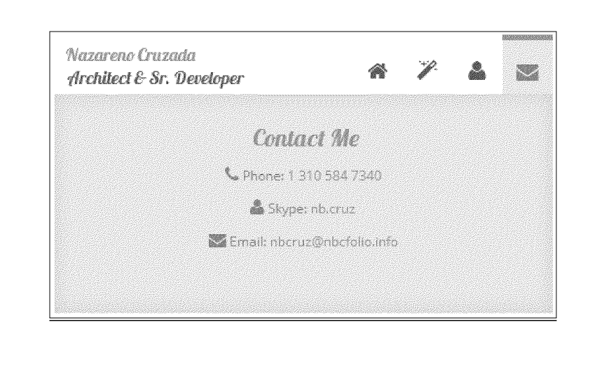

2. A method of an embodiment of the digital card of claim 1 where the digital card represents a business card; wherein the HTML file uses a markup format of a card owner's vCard or .vcf contact information using the “id” attribute as a unique identifier for an element containing data for a vCard field, as shown in FIG. 2.

3. A method of an embodiment of the digital card of claim 1 wherein the HTML file provides interactivity via the use of hyperlinks, buttons, mailto tags, tel tags or custom tags that may launch the mobile phone's dialer when clicked.

4. A mobile app installed on a user's mobile phone that:
contains a mini web browser screen that presents the electronic interactive card of claim 1 for interactive viewing by a user;
allows a user to create, view, transmit, store and organize the electronic interactive cards of claim 1; wherein a user of the system can use the mobile app to send his or her card to another user; wherein the mobile app transmits the user's card files in the package file format using either the SMTP internet messaging protocol, the MMS messaging protocol, near field communications (NFC) technology, acoustic signals, or via a Bluetooth connection to the recipient's mobile device; wherein the transmitted message containing the card package file contains a link to download and install the mobile app;
contains a directory structure that allows the user to create directories, folders and sub-folders to organize the stored card files into categories such as industry or profession; wherein a user may elect to create directories, folders or sub-folders with names such as “Dentists”, “Real Estate”, “DC Attorneys”, etc.;
stores each card within the directory structure in an individual sub-folder that contains all the files associated with one card;
provides a screen that allows the user to navigate thru the directories, folders and sub-folders that contain the stored card files, list the cards stored in each directory or sub-folder, and to sort the stored cards in ascending or descending order;
presents a listing screen showing a list of cards stored in each directory, folder or sub-folder by reading and retrieving data from the vCard or .vcf file associated with each card to present the card owner's contact information onto the list;
presents a web view or graphical view of a user selected card on a screen when a user clicks or taps on a list item on the listing screen;
presents a Card Design Wizard comprising of multiple screens which allow the app user to create a new digital card by choosing a card template from an image thumbnail list of available card templates and allowing the user to choose image files local to the device to customize the card.
provides capability for a user to save or import the contact info of a business card into the user's phone contacts database.

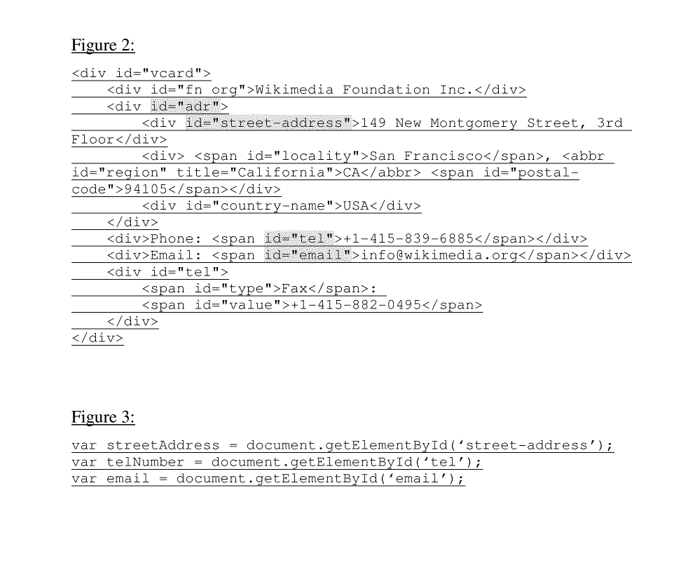

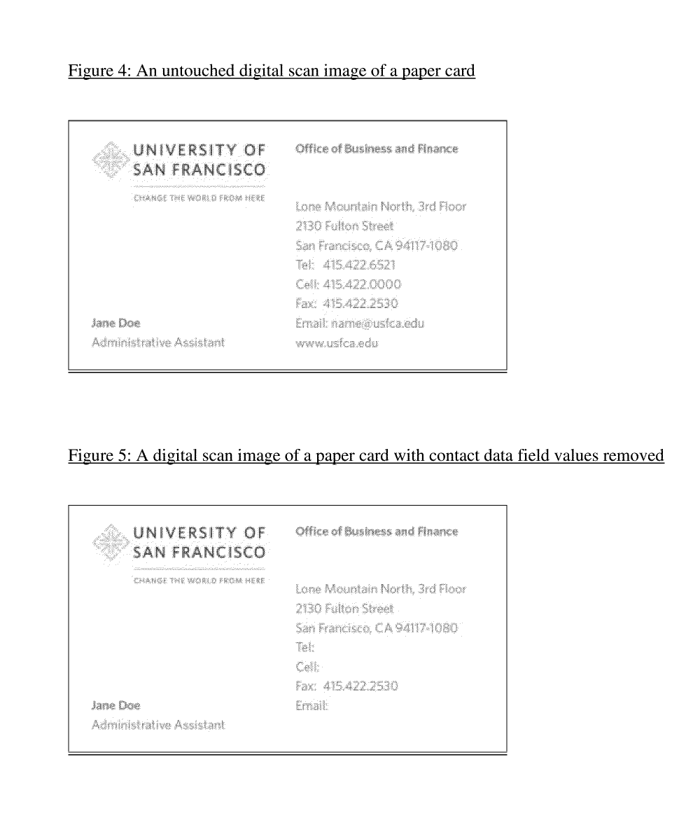

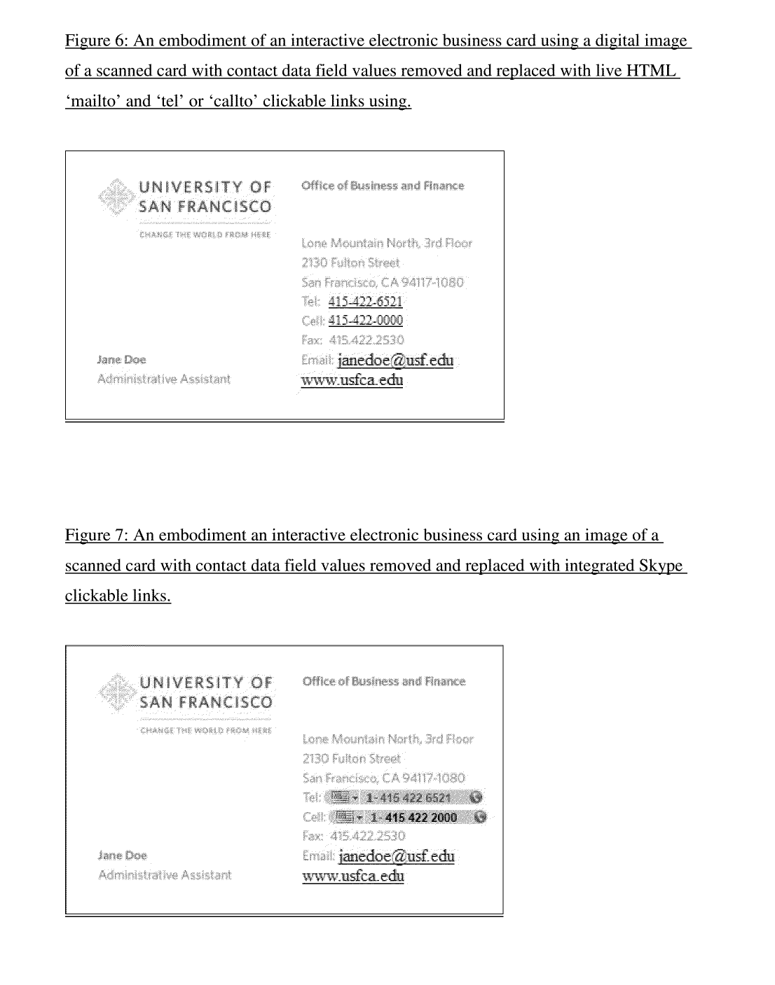

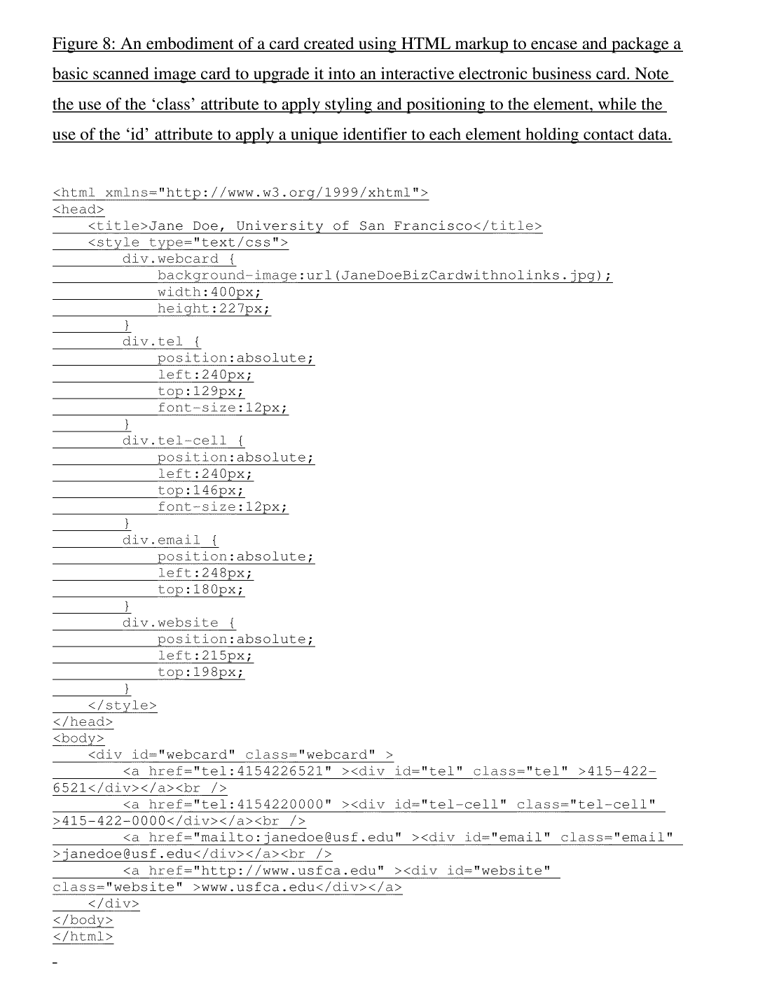

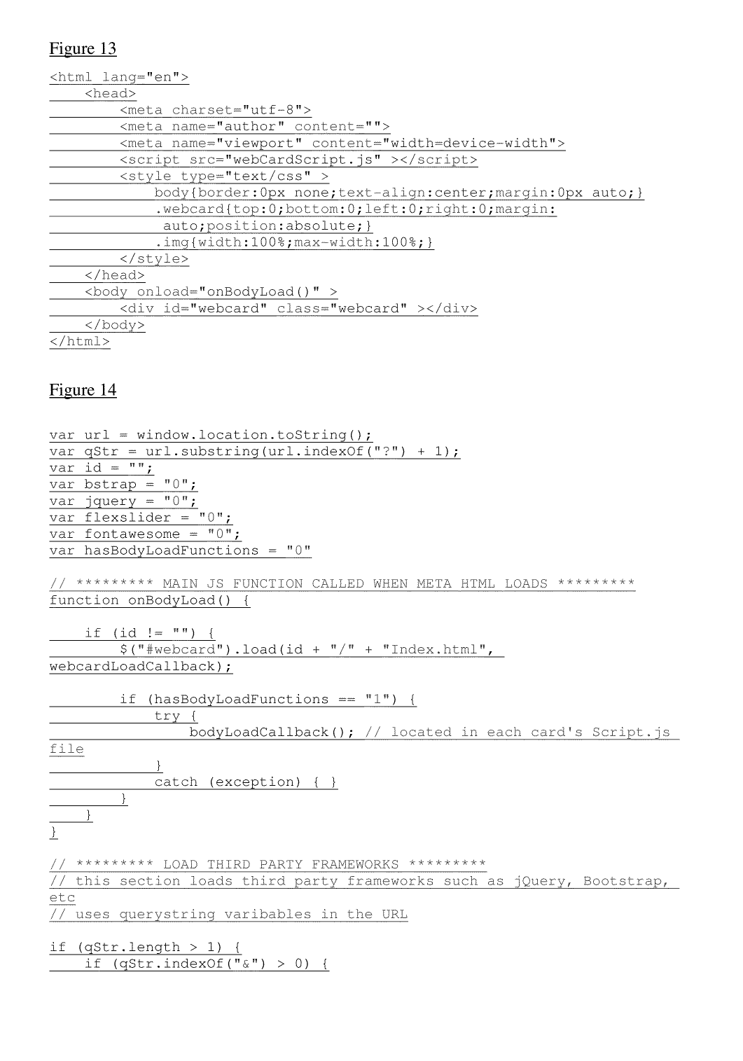

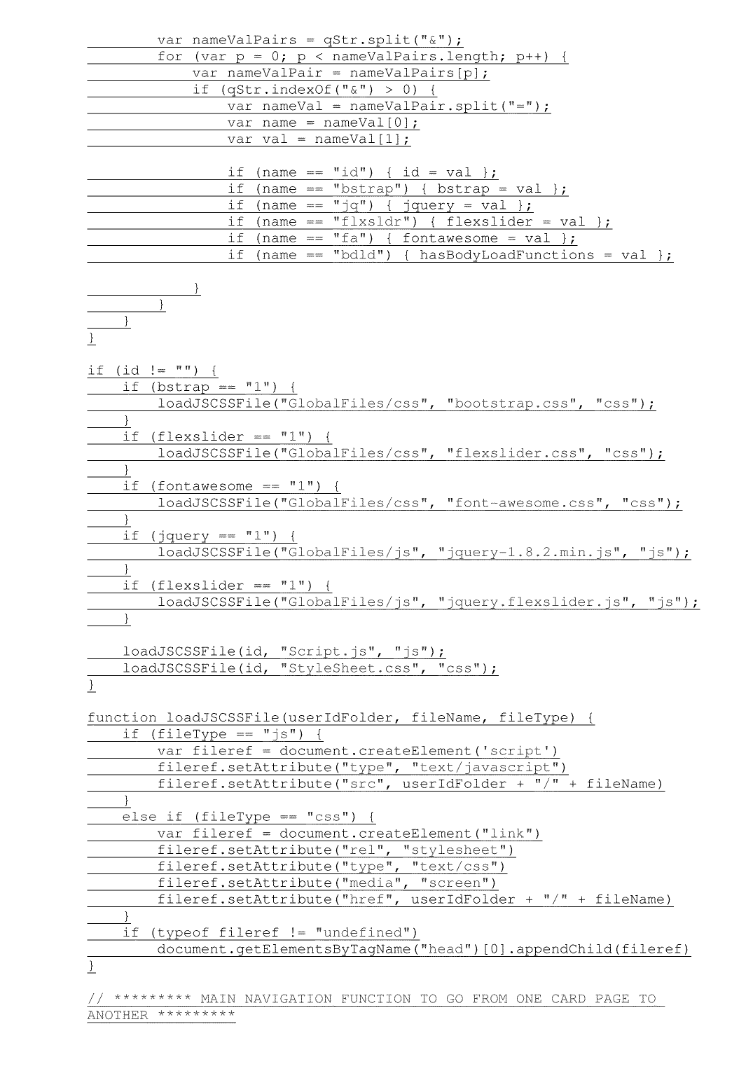

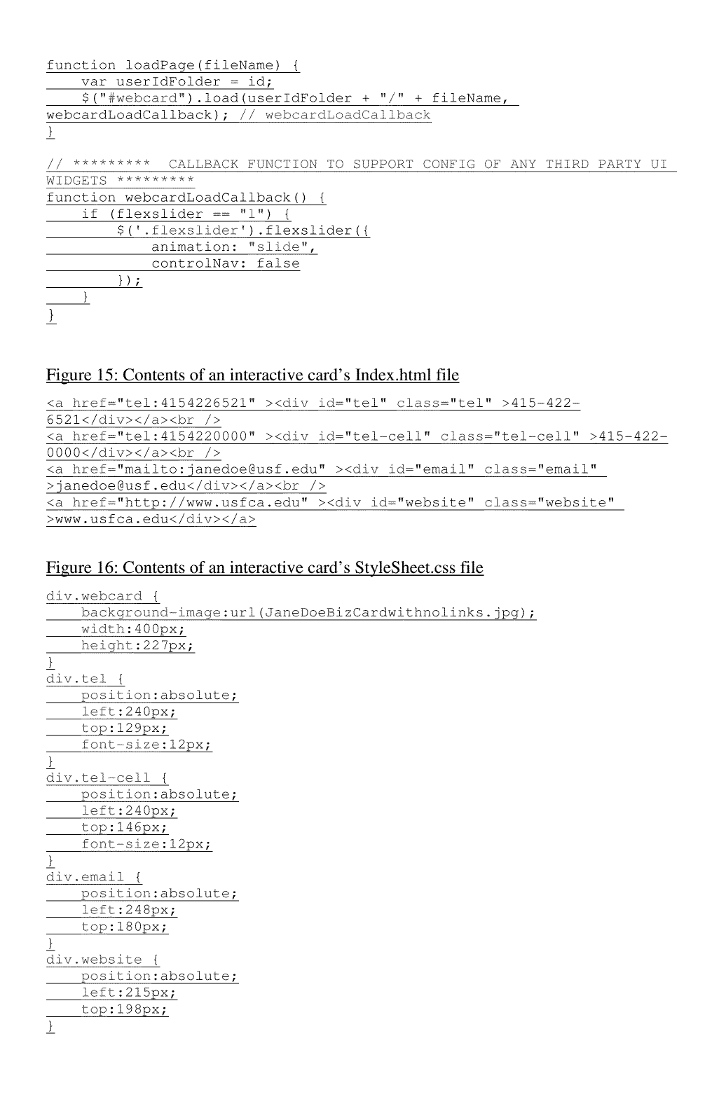

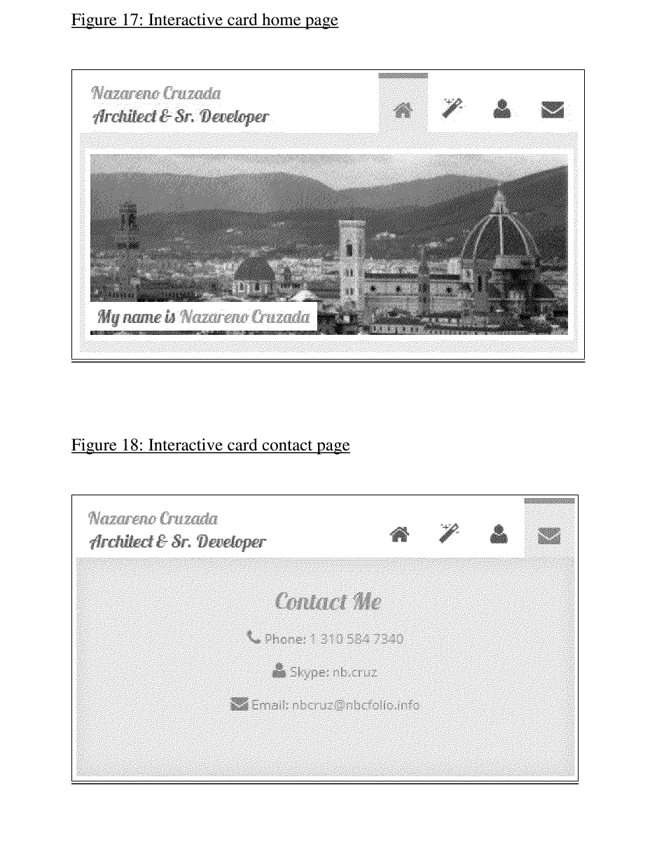

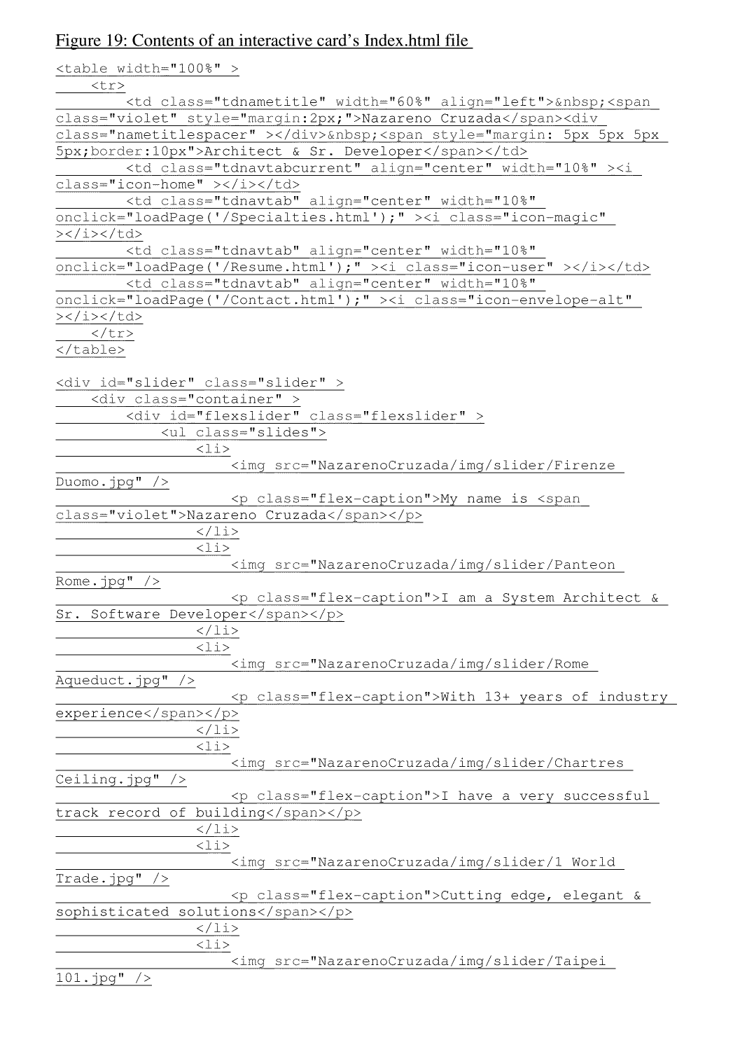

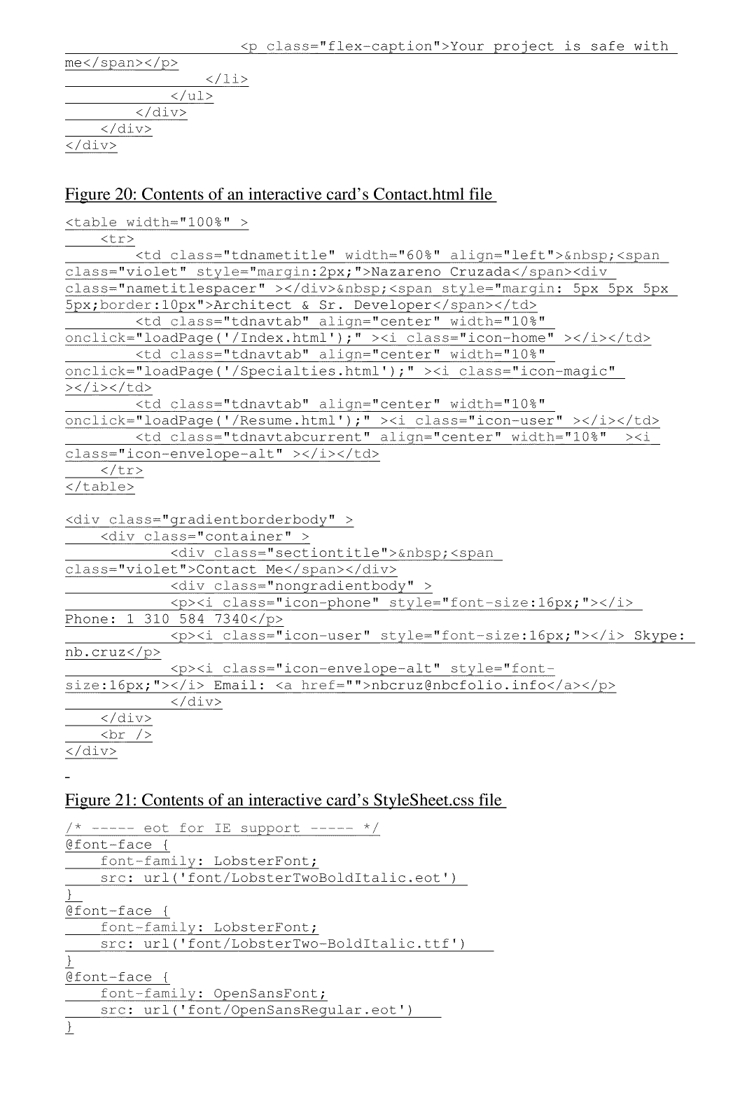

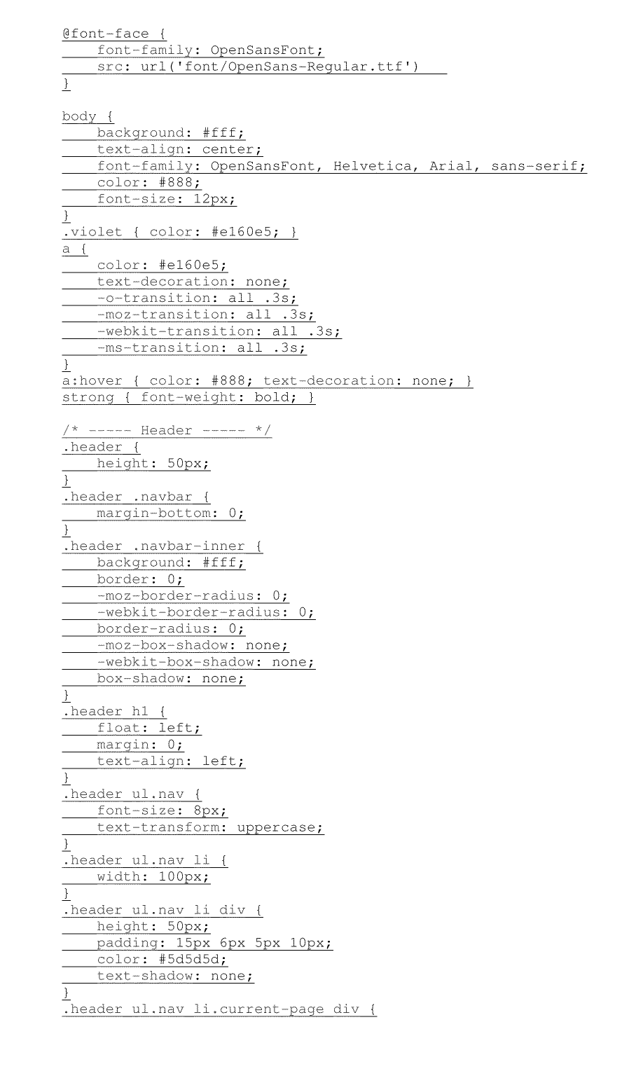

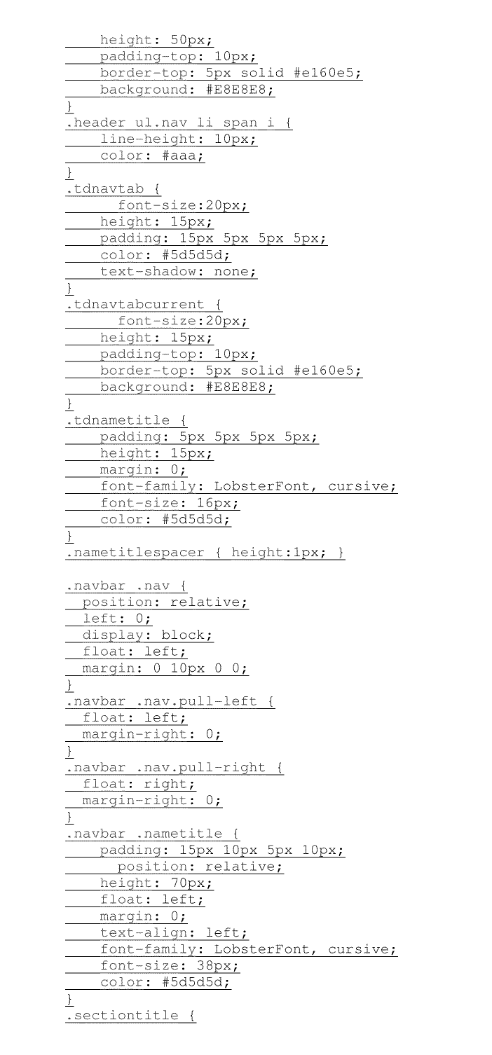

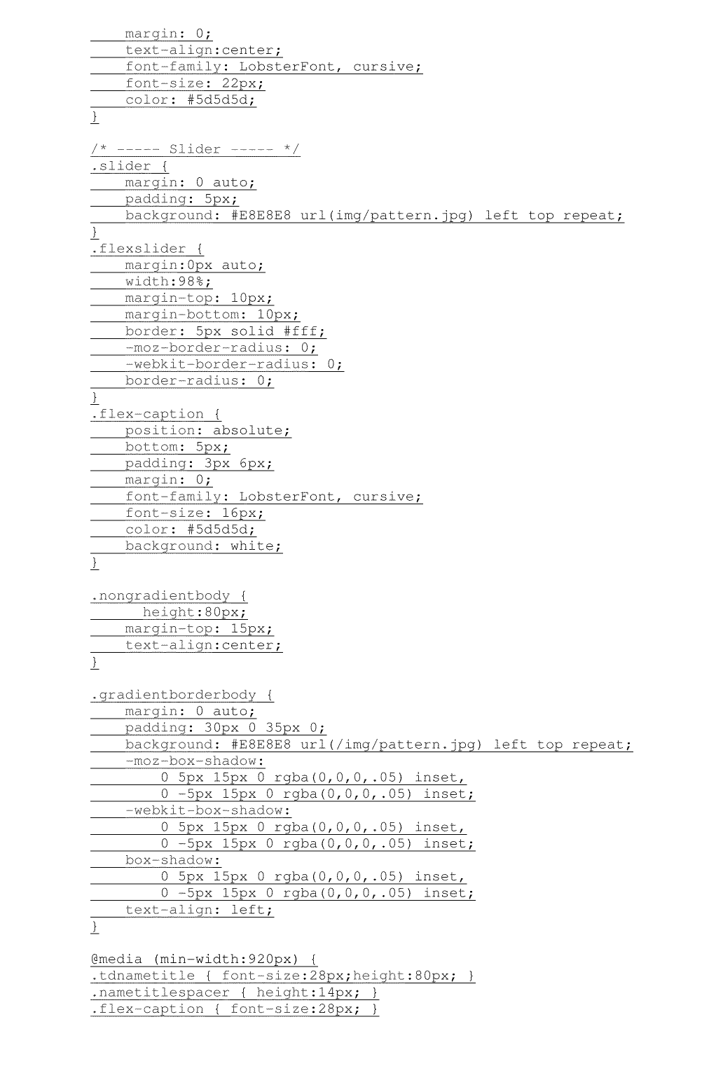

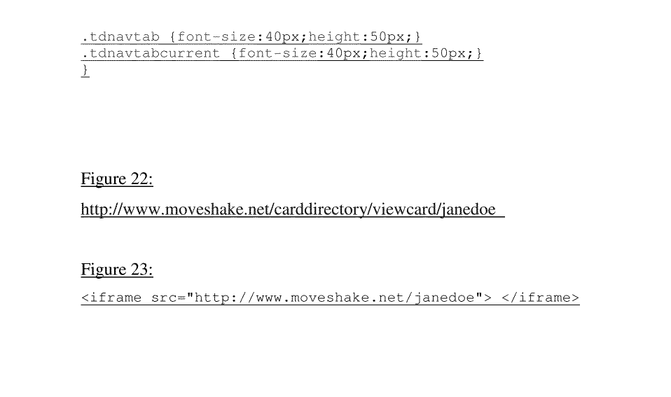

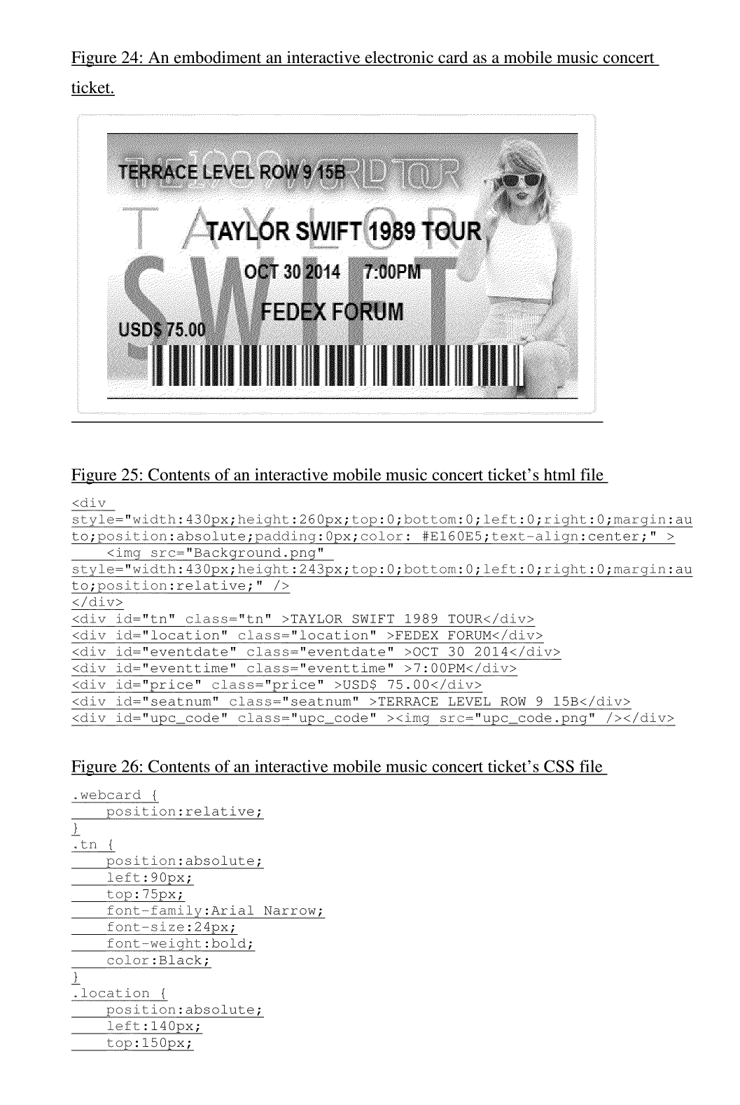

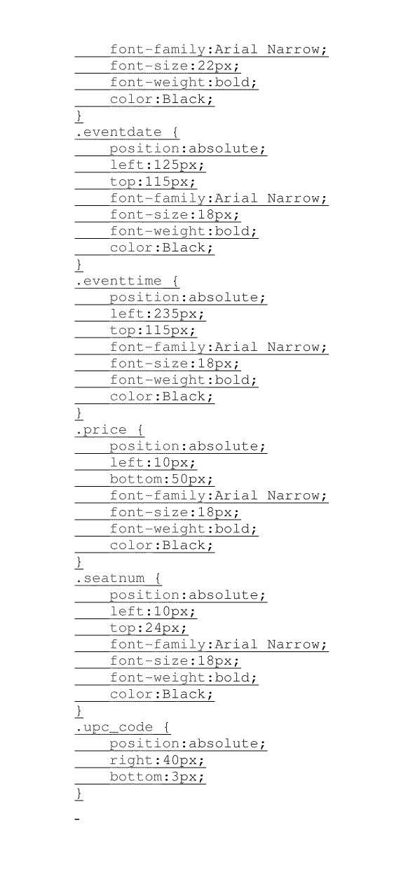

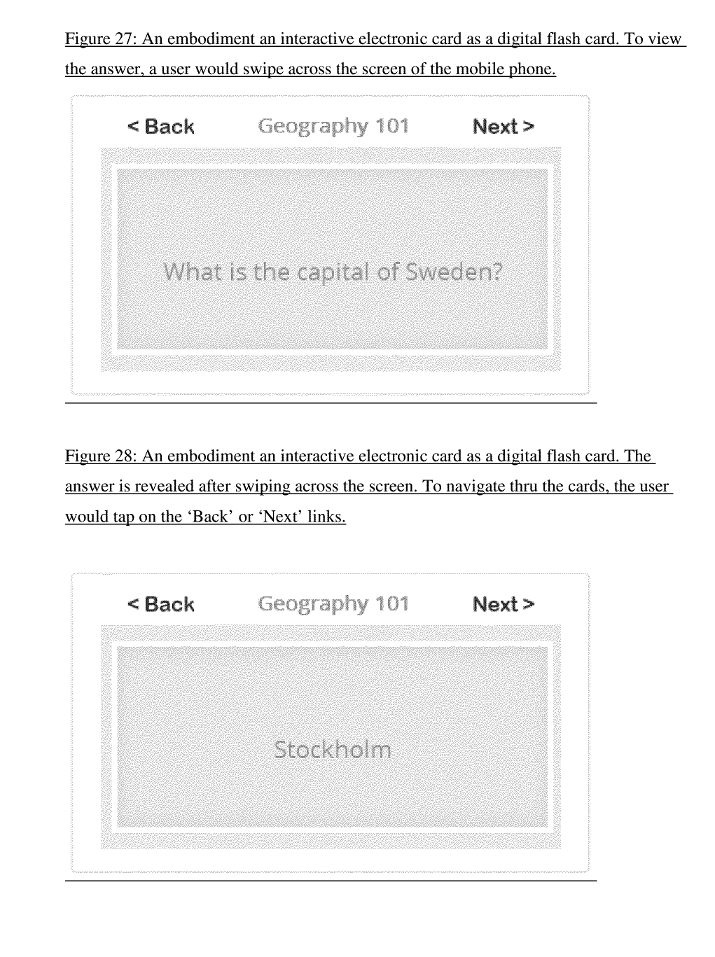

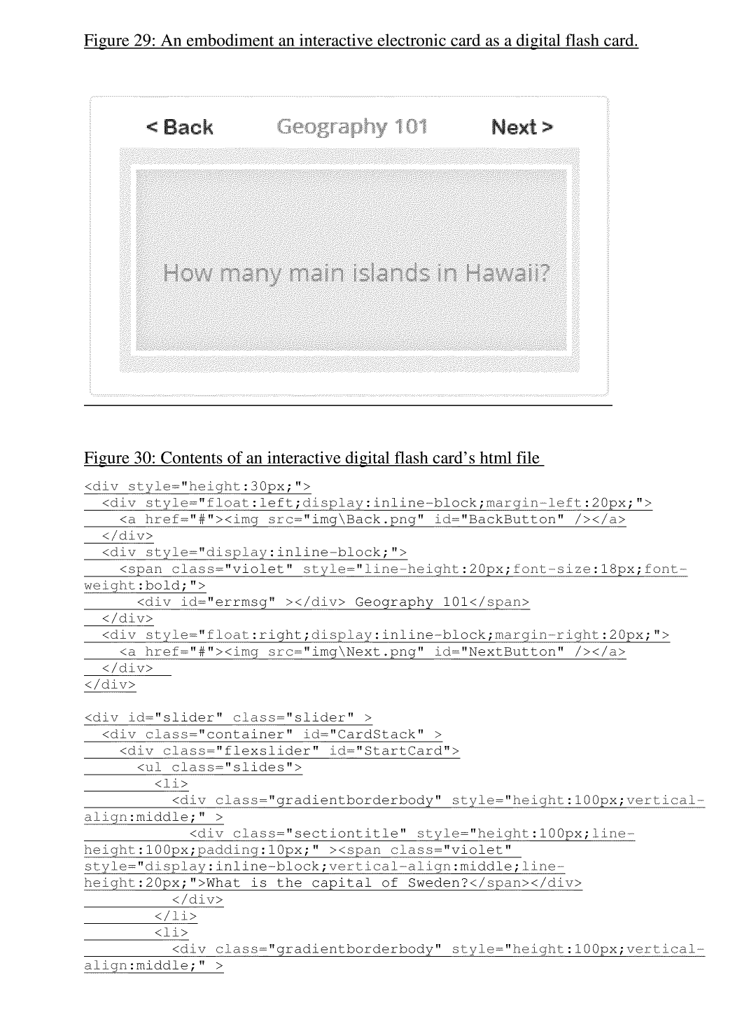

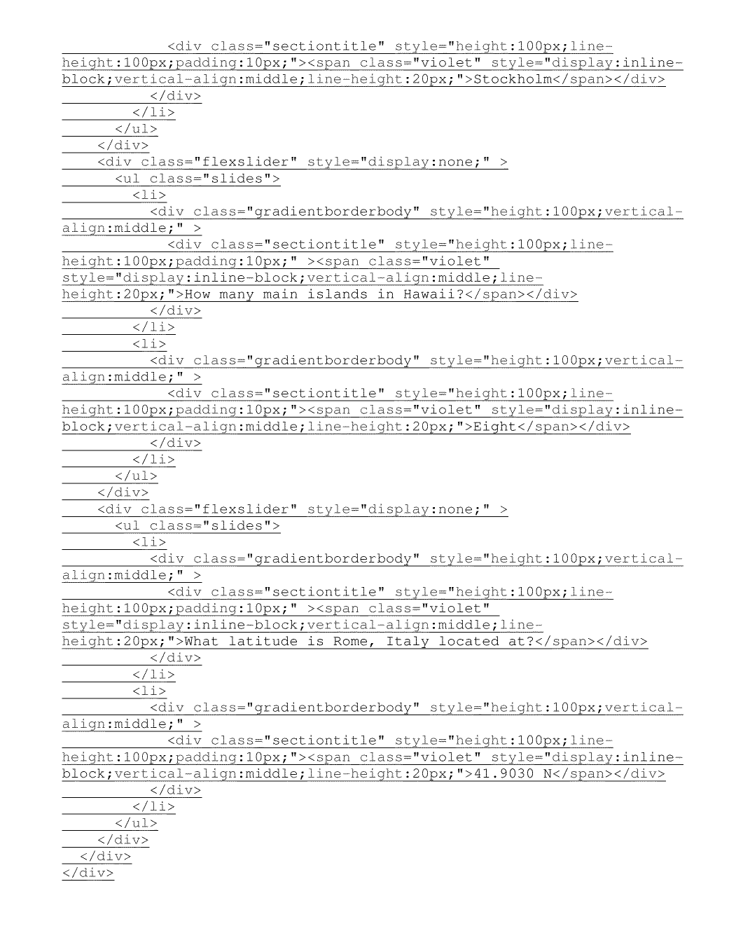

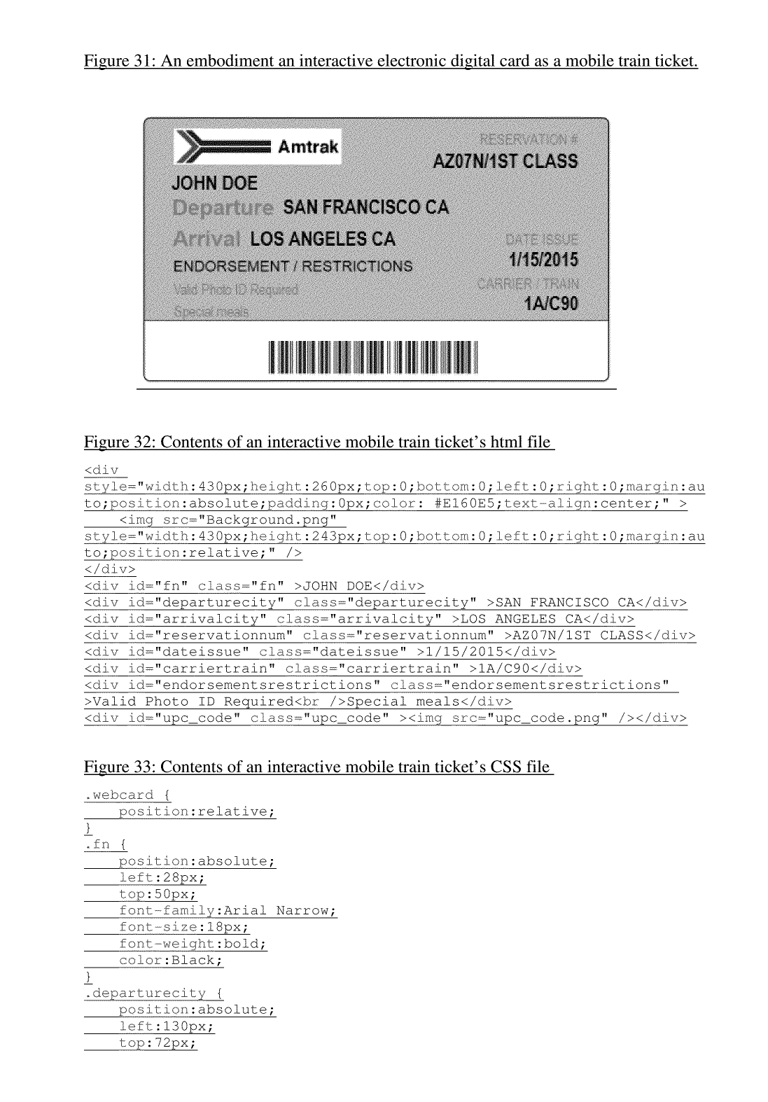

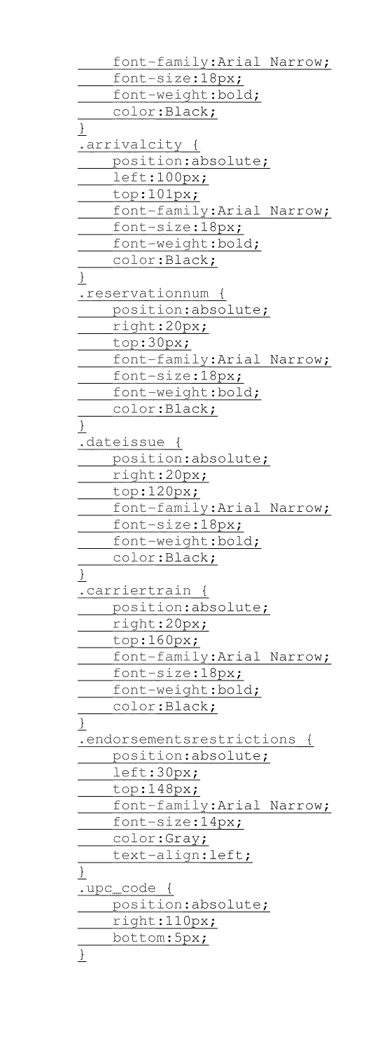

5. A computer implemented method of the mobile app of claim 4 wherein a value of a vCard field embedded in an HTML file is retrieved by using the getElementById function of a programming language such as Javascript, as shown in FIG. 3.

6. A digital card design tool and integrated design environment for web-based interactive cards, embodied as either an online browser-based application or desktop application; wherein this design environment includes card design tools including but not limited to: a project workspace container, a project workspaces manager, a multi-page design management screen, a code editor, a code validator, a design preview screen, image file uploader, a third party framework loader, a card files packager, and a framework of meta HTML, CSS and Javascript files that provide graphical presentation and navigation infrastructure for the card, implements standard coding and file naming conventions, and provides a security infrastructure to prevent rogue code from executing on a user's mobile device.

7. An interactive electronic digital card and a system for the design, creation, publishing, viewing, transmitting, storing and organizing of electronic digital cards comprising of the interactive electronic digital card of claim 1, a plurality of mobile apps of claim 4, a central website, the digital card design tool and integrated design environment of claim 6, and a remote server.

8. The remote server of the system of claim 7, also called the card server, that functions as the central hub of communications with the design tool and the mobile app; wherein the design tool communicates with this remote server when a card designer wants to publish his or her card to this remote server; wherein the mobile app communicates with this remote server when a user wants to upload his or her card to the public directory or to download a public card from the directory; wherein the mobile app communicates with this remote server when a user wants to back up his or her collection of received cards to the cloud or to retrieve a backup from the cloud; and wherein this remote server sends system updates or alerts to the mobile app.

9. The remote server of claim 7 wherein the remote server provides cloud backup and retrieval services for a user's received card files.

10. An embodiment of the system of claim 7 wherein a first user has an NFC enabled device, tag or sticker is loaded with unique identifying data about a user's card; wherein this tag or sticker broadcasts this data when another user's NFC enabled device or smartphone is waved near it, transmitting the data to the smartphone; wherein the system's mobile app installed on the other user's device or smartphone can use this unique identifying data to query the remote server to download the first user's card files package.

11. An embodiment of the system of claim 7 implementing a framework of meta HTML, CSS and Javascript files that determines and implements standard coding and file naming conventions, provide graphical presentation and navigation infrastructure for the card, and provides a security infrastructure to prevent rogue code from executing on a user's mobile device.

12. An embodiment of the system of claim 7 including attaching an NFC sticker to the back of a paper business card, thereby enabling it to emit an NFC signal. The NFC sticker would be loaded with the unique card data or ID of a card owner. When the card owner presents the card to a second person, the second person can place an NFC enabled smartphone or device with the mobile app installed in close proximity to the card, thereby allowing the app to read the data on the NFC sticker of the card. If the NFC sticker can hold the entire data of a card package file, the app can download and import the entire contents of the card package file. If the NFC sticker is loaded with a user ID, this data is downloaded by the app and sent to the remote server to request the card package file. If the remote server responds with the card package file, it is then imported by the app into its files storage.

13. A computer implemented method of the mobile app of claim 4 wherein a first mobile device that has the app installed and running communicates with a second mobile device that also has the app installed and running; wherein the app on the first device transmits card ID data converted from digital format into analog acoustic signals via the device's speakers, that are received by a microphone on the second device and converted back from analog signals into digital format by the app on that second device; wherein the app sends the received card ID data to the remote server in order to receive and download the full card file based on the card ID that was received.

14. A computer implemented method of the mobile app of claim 4 wherein the app stores the card ID received from a second device or NFC enabled object when the app cannot connect to the remote server and allows the user to retry communicating with the remote server the next time internet connectivity is available.

15. A computer implemented method of the mobile app of claim 4 wherein a ‘My Cards’ functionality and database provides the ability for the user to store and manage the user's own digital cards; wherein the app has a ‘My Cards’ screen that lists the user's own digital cards stored in the app; wherein the app also provides the ability for the user to design and create digital cards via a user friendly ‘card design wizard’ that houses built-in card design templates and layouts; wherein the app allows the user to save the card into the app's ‘My Cards’ database; wherein the app also allows the user to load digital cards that have been designed by a third party web designer that the user may have paid to design his or her card; wherein the app provides security and credibility by only allowing users to load third party designed cards into this ‘My Cards’ database if the user provides a ‘card design password’ supplied by the card designer.

16. A computer implemented method of the mobile app of claim 4 wherein a Card Directory screen in the app presents a list of locally stored cards and allows the user to add or edit a note for a card in the list by selecting a menu option and showing a screen form to type in and enter the note.

17. A computer implemented method of the mobile app of claim 4 wherein a Card Directory screen provides the ability for a user to save or import the contact info of a business card into the user's phone contacts database; wherein the user can select a card on the directory list and choose a menu option to ‘Save To Contacts’ at which point the app will retrieve the card's contact info and save or import it to the local Contact database of the mobile app.

18. A computer implemented method of the mobile app of claim 4 wherein a Card Directory screen in the app presents a list of card categories such as Art, Business, Finance, Home, Health, Real Estate, etc and allows the user to add a card category to the list by selecting a menu option and showing a screen form to type in and enter the category name.

19. An embodiment of the digital card of claim 1 where the digital card functions as a digital card template that is used to create a digital business card, event ticket, transportation ticket or flash card; and is embodied as an electronic package file such as a ZIP or RAR format, including at least one HTML file; with an option to include one vCard or Virtual Card Format (.vcf) data file, one or more digital image files, a Javascript file, or a CSS file; wherein this digital card is designed and created using an online design tool then uploaded and published to a remote server for download or copy access by a mobile app or an online card design tool and card design studio; wherein this card package file is downloaded or copied then unpackaged or unzipped then used to create a new card design project in the design tool or design studio; or wherein this card package file is downloaded then unpackaged or unzipped by a mobile app and the files stored locally on a mobile device where the app is running; wherein the mobile app provides a Card Templates list screen that shows thumbnail image files that a mobile app user can select a template and the app then creates a digital card using the template files; wherein the newly created digital card files are then uploaded and published to the remote server along with a new Card ID created by the user's username in the system.

20. A computer implemented method of the mobile app of claim 4 wherein a Card Design Wizard guides the user thru the dynamic creation of a digital card by presenting a series of screens which allow the app user to create a new digital card by presenting a screen of an image thumbnail list of available card templates that are located either locally to the mobile device or downloaded from a remote server and allowing the user to choose a specific card template and then allowing the user to customize the card by choosing image files local to the device to replace image files on the card template; wherein the user selects a thumbnail image of a card template, if the template is local to the device, the wizard will copy the local files into a new local folder location for the new card; wherein if the template is online, the wizard will then download the card template files and create a digital card using the downloaded template files; wherein the wizard will also create a new vcf file with the mobile app user's contact info such as first name, last name, job title, company name, etc and saving the digital card files locally in the device storage.

21. A computer implemented method of the mobile app of claim 4 wherein the app allows the user to request to have his or her card preloaded into the app on future downloads and installs of the app; wherein the request is electronically submitted to a remote server and reviewed by a system administrator; wherein approved cards are organized and packaged into a preload package file designated for a particular city or area; wherein a preload package file can contain a plurality of digital cards; wherein a plurality of these preload packages representing multiple cities, zip codes or metropolitan areas are stored in the remote server and gets downloaded by the mobile app the next time the app is installed by a user; wherein the preload package that the remote server gives to the mobile app to download is determined by the current location provided by a GPS or location service on the mobile device that the mobile app is running or is determined by the remote server; wherein the preload package is unpackaged or unzipped by the mobile app and the preloaded cards are stored locally in the mobile device.

22. An embodiment of the digital card of claim 1 where the digital card represents a digital mobile ticket; wherein a mobile app running on a mobile device communicates with a ticketing terminal device via near field communications and receives a card ID value; wherein the mobile app sends this card ID to a remote server to request a mobile ticket package file; wherein a card package representing this mobile ticket is dynamically generated by a remote server; wherein the package creation includes the generation of a unique ticket ID and scan code image using numbering & pricing logic; or wherein the ticket package file is created on the remote server using data provided via an API call to a third party remote ticketing system and the digital ticket has placeholders which gets filled with ticket data fields (event name, ticket number, seat number, scan code, etc) retrieved from the API call; wherein the scan code image can be created by the remote server or by the third party remote ticketing system; or wherein the ticket package file including all ticket data fields is created fully on the third party remote ticketing system then passed by the remote server for download to the mobile app; wherein the mobile app unpackages or unzips the ticket package file upon finish of download, stores the files in a local storage of the mobile device and presents the ticket in a mini web view screen.
